(19) United States
(12) Patent Application Publication
(10) Pub. No.: US 2005/0073149 A1
(43) Pub. Date: Apr. 7, 2005

(54) Coupler assembly for spraying devices

(76) Inventor: Wen Li Guo, Taichung (TW)

Correspondence Address: Wen Li Guo, P.O. Box 65-835, Taichung, 403, TW

(21) Appl. No.: 10/944,568

(22) Filed: Sep. 20, 2004

(30) Foreign Application Priority Data
Oct. 2, 2003 (TW) 092217738

(51) Int. Cl. F16L 19/00

(52) U.S. Cl. 285/353; 285/357

(57) ABSTRACT

A coupler device includes a barrel, a sleeve having an outer thread for engaging with an inner thread of the barrel and for securing the sleeve to the barrel, the sleeve includes an inner peripheral surface having a spatial pattern, and a tubular member includes one end engaged into the sleeve and forced against the sleeve to have the spatial pattern of the sleeve to be transferred onto the tubular member and to form a corresponding spatial pattern on the tubular member, and to have the sleeve to be secured to the tubular member with the spatial patterns of the sleeve and the tubular member. The sleeve may be made of stronger materials for solidly coupling to the barrel.

### BACKGROUND OF THE INVENTION

1. Field of the Invention

The present invention relates to a coupler assembly, and more particularly to a coupler assembly for easily and solidly coupling tubular members of spraying devices or plumbing facilities or the like together.

2. Description of the Prior Art

Typical spraying devices or plumbing facilities or the like comprise two or more housings, casings and/or tubular members that are required to be attached or coupled together, in order to form a water-tight or air-tight sealed passage therein, and to receive air or fluid therein.

For example, U.S. Pat. No. 4,618,100 to White et al. discloses one of the typical spraying devices including a hollow elongated barrel or tubular member directly threaded and coupled to a nozzle housing with a threading engagement. However, normally, the elongated barrel or tubular member is made of plastic or rubber materials, and may not be directly and solidly threaded and coupled to the nozzle housing with the threading engagement.

U.S. Pat. No. 5,127,580 to Fu-I discloses another typical spraying device also including a hollow handle or tubular member having a water output end directly threaded and coupled to a nozzle housing with a threading engagement, and then a compression cap engaged onto the water output end of the tubular member and/or the nozzle housing, in order to secure or couple the tubular member and the nozzle housing together.

However, similarly, the handle or the tubular member is also made of plastic or rubber materials, and may not be solidly threaded and coupled to the nozzle housing with the threading engagement.

U.S. Pat. No. 6,439,472 to Lin et al. discloses a further typical spraying device also including a hollow barrel of a nozzle housing rotatably coupled to a pivot joint, and a compression cap or lock nut engaged onto the hollow barrel and/or the nozzle housing, in order to secure or couple the barrel to the pivot joint.

However, similarly, the barrel or the nozzle housing or the pivot joint is also made of plastic or rubber materials, and may not be solidly threaded and coupled together with the threading engagement.

The present invention has arisen to mitigate and/or obviate the afore-described disadvantages of the conventional coupler assemblies for tubular members of spraying devices or plumbing facilities or the like.

### SUMMARY OF THE INVENTION

The primary objective of the present invention is to provide a coupler assembly for easily and solidly coupling tubular members of spraying devices or plumbing facilities or the like together.

In accordance with one aspect of the invention, there is provided a coupler assembly comprising a barrel including an inner thread formed therein, a sleeve including an outer thread formed thereon for engaging with the inner thread of the barrel, and for securing the sleeve to the barrel, the sleeve including an inner peripheral surface having a spatial pattern provided therein, and a tubular member including a first end engaged into the sleeve, and forced against the sleeve, to have the spatial pattern of the sleeve to be transferred onto the first end of the tubular member and to form a corresponding spatial pattern on the first end of the tubular member, and to have the sleeve to be secured to the first end of the tubular member with the spatial patterns of the sleeve and the tubular member. The first end of the tubular member is thus capable of easily and readily and solidly coupled to the barrel with the sleeve.

The spatial pattern of the sleeve includes at least one peripheral depression and at least one peripheral protrusion formed therein, to forming corresponding peripheral protrusion and peripheral depression in the first end of the tubular member, and thus to allow the sleeve and the tubular member to be solidly secured together with the spatial patterns.

The first end of the tubular member includes a peripheral flange extended radially and outwardly therefrom, to engage with the sleeve, and to solidly anchor the tubular member to the sleeve. The sleeve includes an inner peripheral recess formed therein, to receive the peripheral flange of the tubular member, and to further solidly anchor the tubular member to the sleeve.

The barrel includes a gasket disposed therein and engaged with the first end of the tubular member, to make a water tight seal between the barrel and the first end of the tubular member. For example, a housing may be provided and may have a rear wall, and may have the barrel extended from the rear wall of the housing.

The housing includes a peripheral rib extended radially into the barrel, to form a narrowed orifice between the housing and the barrel, and the gasket is engaged with the peripheral rib of the housing. The housing includes a filter screen disposed in the orifice thereof and engaged with the peripheral rib of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a coupler assembly in accordance with the present invention for spraying devices or plumbing facilities or the like;

FIG. 2 is a partial cross sectional view of the coupler assembly for the spraying devices or the plumbing facilities or the like;

FIG. 3 is a partial cross sectional view similar to FIG. 2, illustrating another arrangement of the coupler assembly;

FIG. 4 is an enlarged partial cross sectional view similar to FIGS. 2 and 3, illustrating a further arrangement of the coupler assembly;

FIG. 5 is an enlarged cross sectional view illustrating a sleeve of the coupler assembly;

FIGS. 6, 7, 8 are enlarged cross sectional views similar to FIG. 5, illustrating the other configurations of the sleeve of the coupler assembly;

FIG. 9 is an end view illustrating a further configuration of the sleeve of the coupler assembly; and

FIGS. 10, 11, 12, 13 are perspective views illustrating the still further configurations of the sleeve of the coupler assembly.

### DETAILED DESCRIPTION OF THE PREFERRED EMBODIMENT

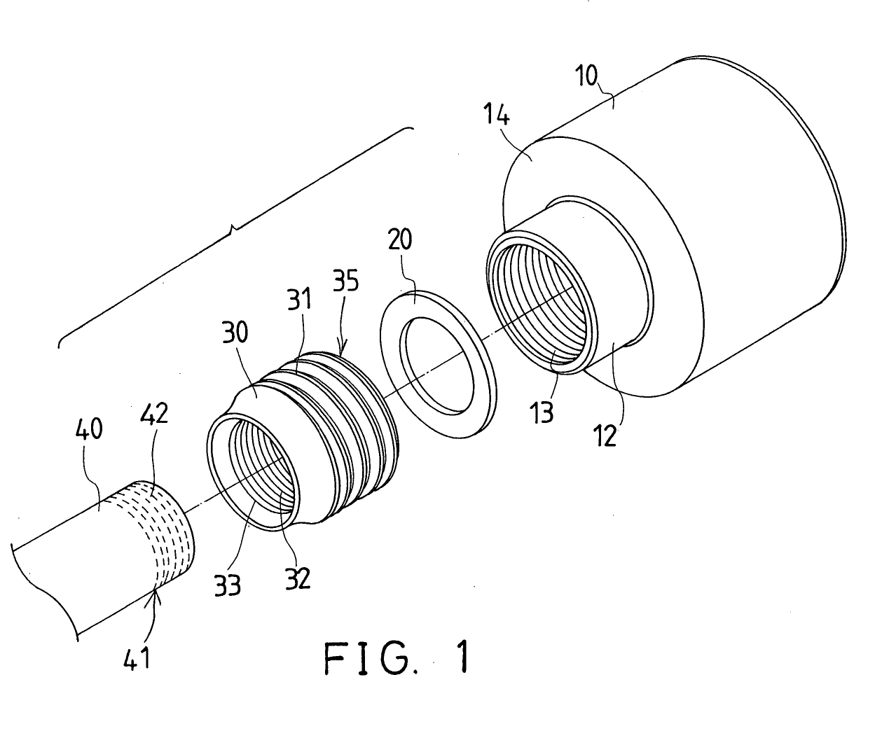

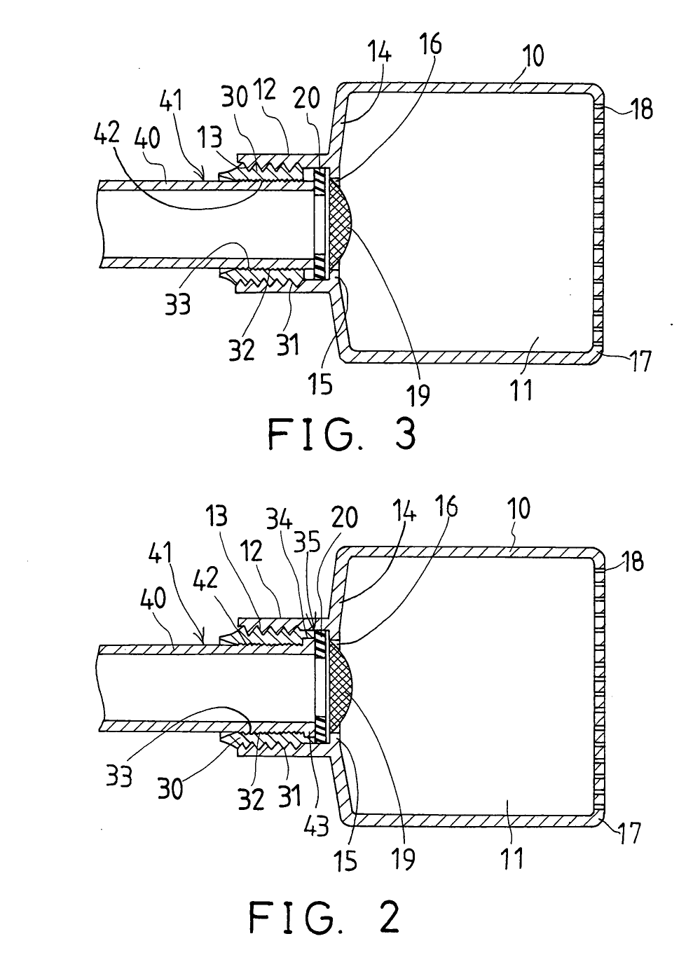

Referring to the drawings, and initially to FIGS. 1 and 2, a coupler assembly in accordance with the present invention comprises a housing 10, such as a nozzle housing 10 including a chamber 11 formed therein for receiving water or other fluid therein, and including a barrel 12 extended therefrom, such as extended rearwardly therefrom, and having an inner thread 13 formed therein, for threading or coupling with a tubular member 40 or the like.

It is preferable that the housing 10 includes a rear wall 14 having the barrel 12 extended rearwardly therefrom, and having a peripheral rib 15 extended radially into the barrel 12, to form or define a narrowed passage or orifice 16 between the housing 10 and the barrel 12. The housing 10 includes a front wall 17 having a number of perforations 18 formed therein, for allowing the water or the fluid to flow out of the housing 10.

A filter screen 19 may further be provided and disposed in the orifice 16 of the housing 10 and engaged with the peripheral rib 15 of the housing 10, for filtering the water or the fluid. A sealing ring or a gasket 20 may be disposed or engaged into the barrel 12, and engaged with or anchored by the peripheral rib 15 of the housing 10, for making a water-tight or air-tight seal between the housing 10 and/or the barrel 12 and the tubular member 40 or the like.

A sleeve 30 is to be attached or secured onto one end 41 of the tubular member 40, and includes an outer thread 31 formed thereon for threading or engaging with the inner thread 13 of the barrel 12, and for coupling and securing the tubular member 40 to the barrel 12. The sleeve 30 includes an inner peripheral surface 32 having a spatial pattern 33 formed or provided therein, for engaging with the outer peripheral surface of the end 41 of the tubular member 40.

For example, the one end 41 of the tubular member 40 may first be engaged into the sleeve 30, and the sleeve 30 may be retained within a mold or retaining device (not shown), and a roller or rotary mold device (not shown) may then be engaged into the one end 41 of the tubular member 40 and forced or moved toward the sleeve 30 and the mold or retaining device (not shown), in order to force or roll or clamp the one end 41 of the tubular member 40 and the sleeve 30 together (FIGS. 2-4).

After the clamping or rolling processes, the spatial pattern 33 of the sleeve 30 may be forced or formed or transferred onto the outer peripheral surface of the one end 41 of the tubular member 40, in order to form a similar or identical spatial pattern 42 on the one end 41 of the tubular member 40, and so as to allow the one end 41 of the tubular member 40 and the sleeve 30 to be solidly secured or fixed together by the relatively engaged patterns 33, 42 of the sleeve 30 and the tubular member 40.

During the clamping or rolling processes, the one end 41 of the tubular member 40 may further be rolled or expanded outwardly to form a radially and outwardly extended peripheral flange 43 (FIG. 2), which may be engaged into an inner and peripheral recess 34 that is formed in one end 35 of the sleeve 30, or directly engaged with the one end 35 of the sleeve 30, to further solidly anchor or secure the one end 41 of the tubular member 40 to the sleeve 30, and to prevent the sleeve 30 from being disengaged from the tubular member 40.

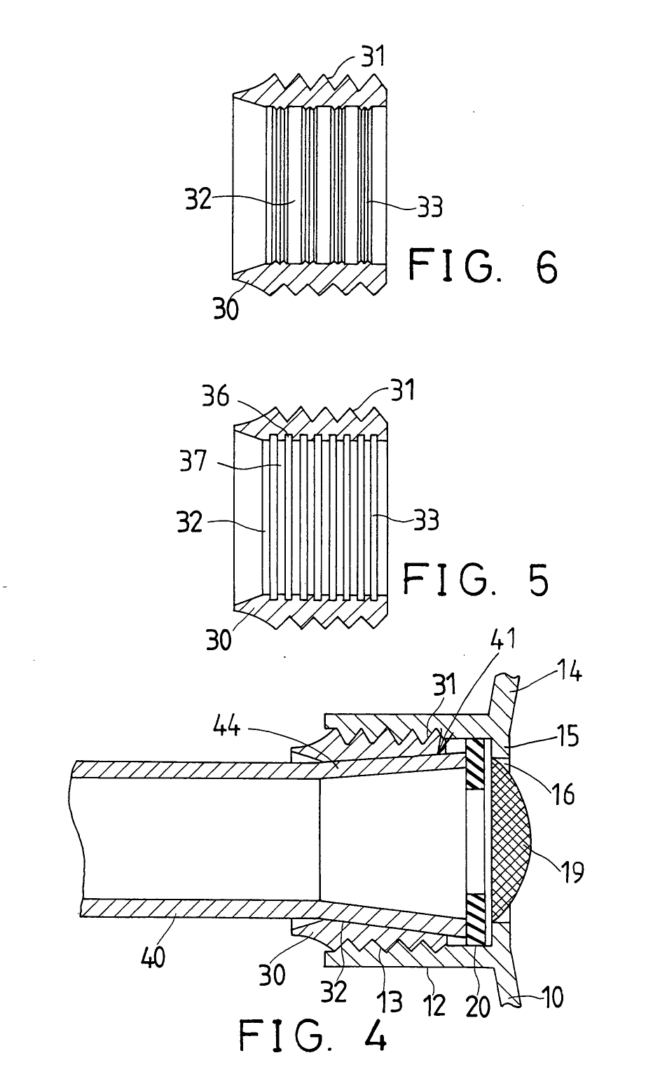

As shown in FIG. 3, the tubular member 40 may also have no peripheral flange formed or provided thereon, i.e., the peripheral flange 43 (FIG. 2) may be selectively, but not necessarily formed on the tubular member 40. As shown in FIG. 4, the one end 41 of the tubular member 40 may be expanded radially or inclinedly outwardly therefrom to form an inclined or tapered segment 44 in the one end 41 thereof, for allowing the one end 41 of the tubular member 40 and the sleeve 30 to be solidly anchored or secured together.

As shown in FIG. 5, the spatial pattern 33 of the sleeve 30 may include one or more peripheral depressions 36 and/or may include one or more peripheral protrusions 37 provided or formed therein, for forming or transferring the corresponding peripheral protrusions and/or peripheral depressions in the spatial pattern 42 of the tubular member 40, and thus to allow the tubular member 40 and the sleeve 30 to be solidly secured together by the spatial patterns 33, 42 of the sleeve 30 and the tubular member 40.

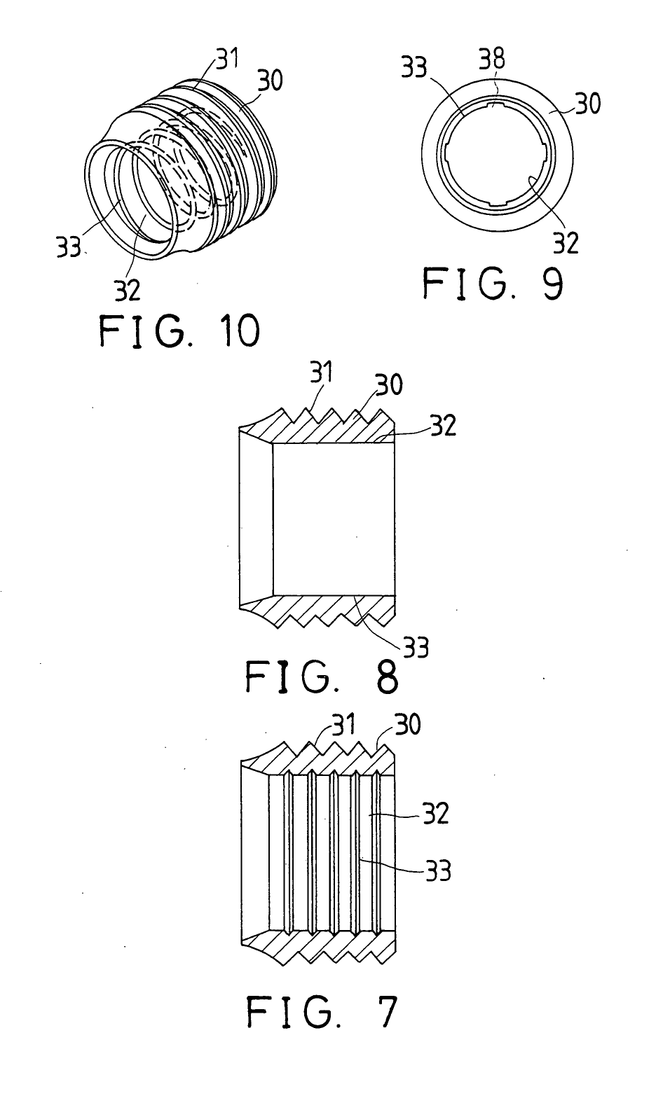

As shown in FIGS. 6-13, the spatial pattern 33 of the sleeve 30 may further be formed into various kinds of shapes. For example, the peripheral depressions 36 and the peripheral protrusions 37 may be formed in groups and separated from each other (FIG. 6), or formed into wedge shaped or triangular shaped peripheral depressions (FIG. 7), or having a flat structure (FIG. 8), or having one or more longitudinal grooves 38 formed therein (FIGS. 9, 13).

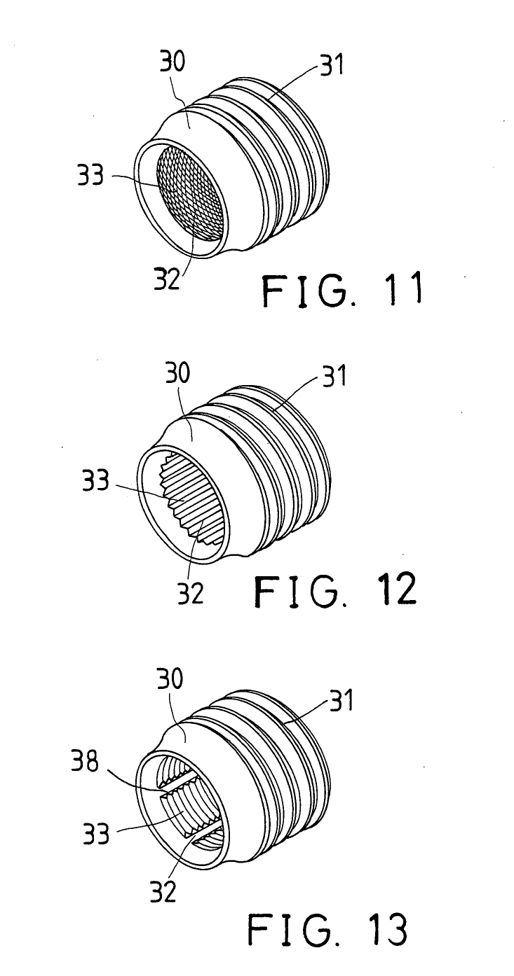

The spatial pattern 33 of the sleeve 30 may also be formed into a helical shaped spatial pattern (FIG. 10), or formed into an inclined and/or cross-shaped spatial pattern (FIG. 11), or formed into longitudinal groove-shaped spatial pattern (FIG. 12), or the like.

In operation, the sleeve 30 may first be attached or secured onto one end 41 of the tubular member 40, and rolled or clamped onto the tubular member 40 by such as clamping or rolling processes, to allow the spatial pattern 33 of the sleeve 30 to be forced or transferred onto the outer peripheral surface of the one end 41 of the tubular member 40, in order to form the spatial pattern 42 on the one end 41 of the tubular member 40, and thus for allowing the sleeve 30 to be solidly secured onto the one end 41 of the tubular member 40 with the spatial patterns 33, 42 of the sleeve 30 and the tubular member 40.

The sleeve 30 may then be threaded with the inner thread 13 of the barrel 12, to easily and readily and solidly couple and secure the tubular member 40 to the barrel 12. It is to be noted that the sleeve 30 may be made of stronger materials, such as metal or other synthetic materials, for solidly engaging with the barrel 12, and thus for solidly coupling and securing the sleeve 30 and thus the tubular member 40 to the barrel 12.

Accordingly, the coupler assembly in accordance with the present invention may be used for easily and solidly coupling tubular members of spraying devices or plumbing facilities or the like together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A coupler assembly comprising:
a barrel including an inner thread formed therein,
a sleeve including an outer thread formed thereon for engaging with said inner thread of said barrel, and for securing said sleeve to said barrel, said sleeve including an inner peripheral surface having a spatial pattern provided therein, and
a tubular member including a first end engaged into said sleeve, and forced against said sleeve, to have said spatial pattern of said sleeve to be transferred onto said first end of said tubular member and to form a corresponding spatial pattern on said first end of said tubular member, and to have said sleeve to be secured to said first end of said tubular member with said spatial patterns of said sleeve and said tubular member,
said first end of said tubular member being capable of easily coupled to said barrel with said sleeve.

2. The coupler assembly as claimed in claim 1, wherein said spatial pattern of said sleeve includes at least one peripheral depression and at least one peripheral protrusion formed therein.

3. The coupler assembly as claimed in claim 1, wherein said first end of said tubular member includes a peripheral flange extended radially and outwardly therefrom, to engage with said sleeve, and to solidly anchor said tubular member to said sleeve.

4. The coupler assembly as claimed in claim 3, wherein said sleeve includes an inner peripheral recess formed therein, to receive said peripheral flange of said tubular member, and to further solidly anchor said tubular member to said sleeve.

5. The coupler assembly as claimed in claim 1, wherein said barrel includes a gasket disposed therein and engaged with said first end of said tubular member, to make a water tight seal between said barrel and said first end of said tubular member.

6. The coupler assembly as claimed in claim 5 further comprising a housing having a rear wall, and having said barrel extended from said rear wall of said housing.

7. The coupler assembly as claimed in claim 6, wherein said housing includes a peripheral rib extended radially into said barrel, to form a narrowed orifice between said housing and said barrel, and said gasket is engaged with said peripheral rib of said housing.

8. The coupler assembly as claimed in claim 7, wherein said housing includes a filter screen disposed in said orifice thereof and engaged with said peripheral rib of said housing.
